(19) United States
(12) Patent Application Publication
(10) Pub. No.: US 2012/0113898 A1
(43) Pub. Date: May 10, 2012

(54) USING PRECODING VECTOR SWITCHING IN UPLINK CONTROL CHANNEL

(75) Inventors: Xiliang Luo, Cardiff, CA (US); Peter Gaal, San Diego, CA (US); Wanshi Chen, San Diego, CA (US); Juan Montojo, San Diego, CA (US)

(73) Assignee: QUALCOMM Incorporated, San Diego, CA (US)

(21) Appl. No.: 13/283,424

(22) Filed: Oct. 27, 2011

Related U.S. Application Data
(60) Provisional application No. 61/411,909, filed on Nov. 9, 2010.

(51) Int. Cl. H04W 4/00

(52) U.S. Cl. 370/328; 370/310

(57) ABSTRACT

Methods and apparatuses are provided that include using orthogonal precoding vectors to precode signals for transmission in a given subframe. Transmissions in a first slot of the subframe can be precoded with a first precoding vector, and transmissions in a second slot of the subframe can be precoded with a second precoding vector, which can be orthogonal to the first precoding vector. The precoding vectors can be selected using precoding vector switching or a similar mechanism. Thus, diversity is provided for transmissions within a given subframe to improve reliability of receiving the transmissions. In addition, other precoding vectors can be used to precode signals for transmissions in a subsequent subframe.

### CLAIM OF PRIORITY UNDER 35 U.S.C. §119

The present Application for Patent claims priority to U.S. Provisional Application No. 61/411,909, entitled, “USING PRECODING VECTOR SWITCHING IN UPLINK CONTROL CHANNEL,” filed Nov. 9, 2010, and assigned to the assignee hereof and hereby expressly incorporated by reference herein.

### BACKGROUND

1. Field

Aspects of the present disclosure relate generally to wireless communication systems, and more particularly, to providing transmit diversity in uplink communication.

2. Background

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that can support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station. In an example, a base station can assign a number of downlink and/or uplink resources to a UE. Moreover, the base station can allow the UE to establish multiple carriers for communicating with the base station over the downlink or uplink using multiple physical or virtual antennas or other radio resources to improve communication throughput.

### SUMMARY

The following presents a simplified summary of one or more aspects to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, the present disclosure describes various aspects in connection with applying a transmit diversity scheme to communications transmitted over multiple physical or virtual antenna ports to a base station. For example, signals including control data can be transmitted over the multiple antennas according to one or more precoding vectors or matrices to improve reliability in receiving such signals. In an example, a control channel transmission can utilize a first precoding vector in a first slot of a subframe, and a second precoding vector in a second slot of the subframe to provide improved transmission diversity.

According to an example, a method for transmitting wirelessly using transmit diversity is provided. The method includes selecting a first plurality of orthogonal precoding vectors and transmitting, in a first subframe, a first plurality of control transmissions orthogonalized using the first plurality of orthogonal precoding vectors.

In another example, an apparatus for transmitting wirelessly using transmit diversity is provided that includes means for selecting a first plurality of orthogonal precoding vectors and means for transmitting, in a first subframe, a first plurality of control transmissions orthogonalized using the first plurality of orthogonal precoding vectors.

Moreover, for example, a computer program product for transmitting wirelessly using transmit diversity is provided that includes a non-transitory computer-readable medium. The computer-readable medium can have code for causing at least one computer to select a first plurality of orthogonal precoding vectors and code for causing the at least one computer to transmit, in a first subframe, a first plurality of control transmissions orthogonalized using the first plurality of orthogonal precoding vectors.

In yet another example, a user equipment (UE) supporting uplink transmit diversity is provided. The UE includes at least one processor and a memory coupled to the at least one processor. The processor can be configured to select a first plurality of orthogonal precoding vectors and transmit, in a first subframe, a first plurality of control transmissions orthogonalized using the first plurality of orthogonal precoding vectors.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram conceptually illustrating an example of a telecommunications system;

FIG. 2 is a block diagram conceptually illustrating an example of a down link frame structure in a telecommunications system;

FIG. 3 is a block diagram conceptually illustrating is a block diagram conceptually illustrating a design of a base station/eNB and a UE configured according to one aspect of the present disclosure;

FIG. 4A discloses a continuous carrier aggregation type;

FIG. 4B discloses a non-continuous carrier aggregation type;

FIG. 5 discloses MAC layer data aggregation;

FIG. 6 is a block diagram illustrating a methodology for controlling radio links in multiple carrier configurations;

FIG. 7 is a flowchart representation of an example methodology of wireless communication;

FIG. 8 is a block diagram representation of a portion of a wireless communication apparatus;

FIG. 9 is a flowchart representation of an example methodology of wireless communication; and

FIG. 10 is a block diagram representation of a portion of a wireless communication apparatus.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

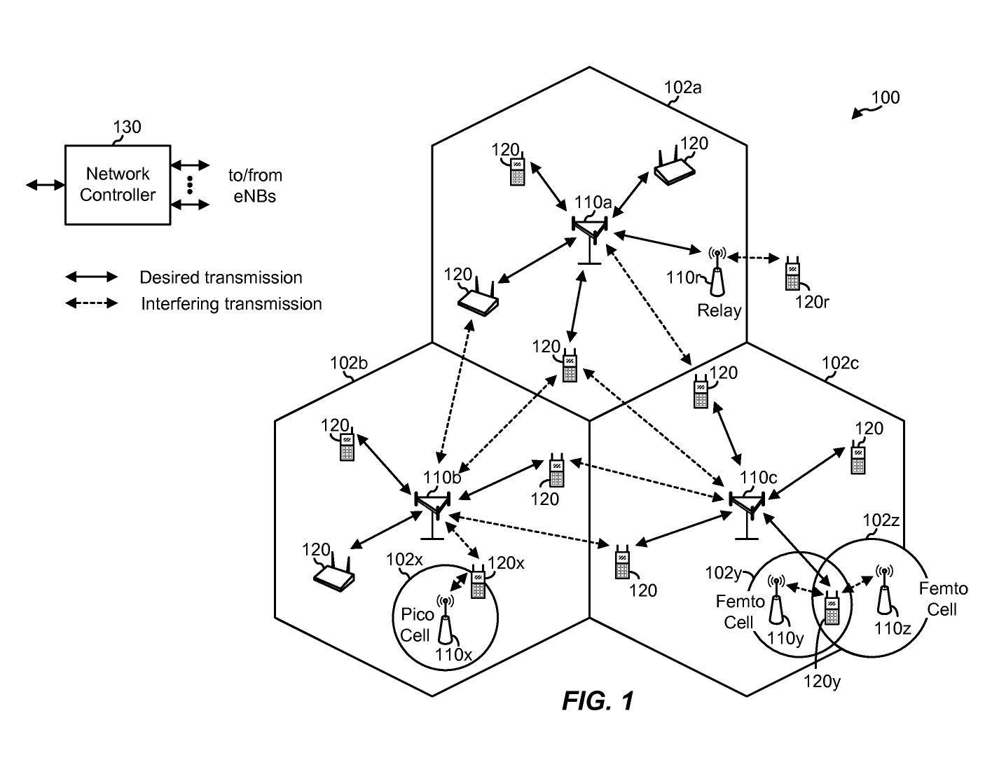

FIG. 1 shows a wireless communication network 100, which may be an LTE network. The wireless network 100 may include a number of evolved Node Bs (eNBs) 110 and other network entities. An eNB may be a station that communicates with the UEs and may also be referred to as a base station, a Node B, an access point, etc. Each eNB 110 may provide communication coverage for a particular geographic area. In 3GPP, the term “cell” can refer to a coverage area of an eNB and/or an eNB subsystem serving this coverage area, depending on the context in which the term is used.

An eNB may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG), UEs for users in the home, etc.). An eNB for a macro cell may be referred to as a macro eNB. An eNB for a pico cell may be referred to as a pico eNB. An eNB for a femto cell may be referred to as a femto eNB or a home eNB. In the example shown in FIG. 1, the eNBs 110a, 110b and 110c may be macro eNBs for the macro cells 102a, 102b and 102c, respectively. The eNB 110x may be a pico eNB for a pico cell 102x. The eNBs 110y and 110z may be femto eNBs for the femto cells 102y and 102z, respectively. An eNB may support one or multiple (e.g., three) cells.

The wireless network 100 may also include relay stations. A relay station is a station that receives a transmission of data and/or other information from an upstream station (e.g., an eNB or a UE) and sends a transmission of the data and/or other information to a downstream station (e.g., a UE or an eNB). A relay station may also be a UE that relays transmissions for other UEs. In the example shown in FIG. 1, a relay station 110r may communicate with the eNB 110a and a UE 120r in order to facilitate communication between the eNB 110a and the UE 120r. A relay station may also be referred to as a relay eNB, a relay, etc.

The wireless network 100 may be a heterogeneous network that includes eNBs of different types, e.g., macro eNBs, pico eNBs, femto eNBs, relays, etc. These different types of eNBs may have different transmit power levels, different coverage areas, and different impact on interference in the wireless network 100. For example, macro eNBs may have a high transmit power level (e.g., 20 Watts) whereas pico eNBs, femto eNBs and relays may have a lower transmit power level (e.g., 1 Watt).

The wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time. The techniques described herein may be used for both synchronous and asynchronous operation.

A network controller 130 may couple to a set of eNBs and provide coordination and control for these eNBs. The network controller 130 may communicate with the eNBs 110 via a backhaul. The eNBs 110 may also communicate with one another, e.g., directly or indirectly via wireless or wireline backhaul.

The UEs 120 may be dispersed throughout the wireless network 100, and each UE may be stationary or mobile. A UE may also be referred to as a device, a terminal, a mobile station, a subscriber unit, a station, etc. A UE may be a cellular phone, a personal digital assistant (PDA), a wireless modem (or other tethered device), a wireless communication device, a handheld device, a laptop computer, a tablet or netbook computer, a cordless phone, a wireless local loop (WLL) station, etc. A UE may be able to communicate with macro eNBs, pico eNBs, femto eNBs, relays, etc. In FIG. 1, a solid line with double arrows indicates desired transmissions between a UE and a serving eNB, which is an eNB designated to serve the UE on the downlink and/or uplink. A dashed line with double arrows indicates potentially interfering transmissions between a UE and an eNB.

LTE utilizes orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM or a similar multiplexing scheme and in the time domain with SC-FDM or a similar multiplexing scheme. The spacing between adjacent subcarriers may be fixed, and the total number of subcarriers (K) may be dependent on the system bandwidth. For example, K may be equal to 128, 256, 512, 1024 or 2048 for system bandwidth of 1.25, 2.5, 5, 10 or 20 megahertz (MHz), respectively. The system bandwidth may also be partitioned into subbands. For example, a subband may cover 1.08 MHz, and there may be 1, 2, 4, 8 or 16 subbands for system bandwidth of 1.25, 2.5, 5, 10 or 20 MHz, respectively.

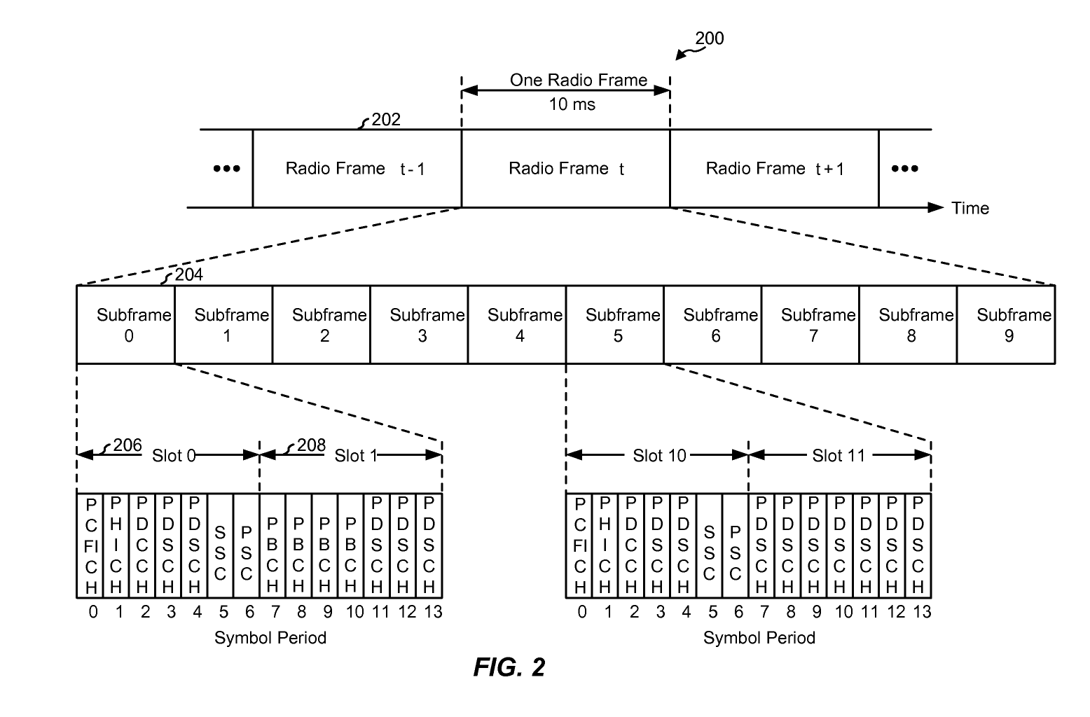

FIG. 2 shows a down link frame structure 200 used in LTE. The transmission timeline for the downlink may be partitioned into units of radio frames, such as radio frame 202. Each radio frame may have a predetermined duration (e.g., 10 milliseconds (ms)) and may be partitioned into 10 subframes with indices of 0 through 9, such as subframe 0 204. Each subframe may include two slots, such as slot 0 206 and slot 1 208. Each radio frame may thus include 20 slots with indices of 0 through 19. Each slot may include L symbol periods, e.g., 7 symbol periods for a normal cyclic prefix (as shown in FIG. 2) or 6 symbol periods for an extended cyclic prefix. The 2L symbol periods in each subframe may be assigned indices of 0 through 2L-1. The available time frequency resources may be partitioned into resource blocks. Each resource block may cover N subcarriers (e.g., 12 subcarriers) in one slot.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix, as shown in FIG. 2. The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in a portion of the first symbol period of each subframe, although depicted in the entire first symbol period in FIG. 2. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. In the example shown in FIG. 2, M=3. The eNB may send a Physical hybrid automatic repeat/request (HARM) Indicator Channel (PHICH) and a Physical Downlink Control Channel (PDCCH) in the first M symbol periods of each subframe (M=3 in FIG. 2). The PHICH may carry information to support hybrid automatic retransmission (HARM). The PDCCH may carry information on resource allocation for UEs and control information for downlink channels. Although not shown in the first symbol period in FIG. 2, it is understood that the PDCCH and PHICH are also included in the first symbol period. Similarly, the PHICH and PDCCH are also both in the second and third symbol periods, although not shown that way in FIG. 2. The eNB may send a Physical Downlink Shared Channel (PDSCH) in the remaining symbol periods of each subframe. The PDSCH may carry data for UEs scheduled for data transmission on the downlink. The various signals and channels can correspond to an LTE configuration.

The eNB may send the PSS, SSS and PBCH in a center of the system bandwidth used by the eNB (e.g., a center 1.08 megahertz (MHz)). The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH and PHICH in a broadcast manner to all UEs, may send the PDCCH in a unicast manner to specific UEs, and may also send the PDSCH in a unicast manner to specific UEs.

A number of resource elements may be available in each symbol period. Each resource element may cover one subcarrier in one symbol period and may be used to send one modulation symbol, which may be a real or complex value. Resource elements not used for a reference signal in each symbol period may be arranged into resource element groups (REG). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1 and 2. The PDCCH may occupy 9, 18, 36 or 72 REGs, which may be selected from the available REGs, in the first M symbol periods. Certain combinations of REGs may be allowed for the PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

A UE may be within the coverage of multiple eNBs. One of these eNBs may be selected to serve the UE. The serving eNB may be selected based on various criteria such as received power, path loss, signal-to-noise ratio (SNR), etc.

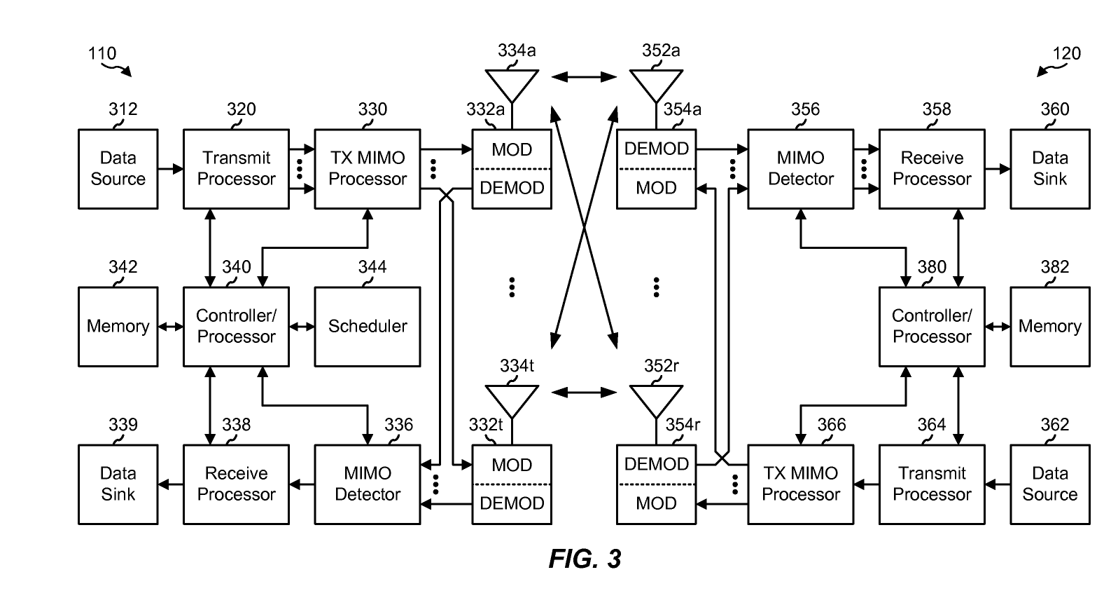

FIG. 3 shows a block diagram of a design of a base station/eNB 110 and a UE 120, which may be one of the base stations/eNBs and one of the UEs in FIG. 1. For a restricted association scenario, the base station 110 may be the macro eNB 110c in FIG. 1, and the UE 120 may be the UE 120y. The base station 110 may also be a base station of some other type. The base station 110 may be equipped with antennas 334a through 334t, and the UE 120 may be equipped with antennas 352a through 352r.

At the base station 110, a transmit processor 320 may receive data from a data source 312 and control information from a controller/processor 340. The control information may be for the PBCH, PCFICH, PHICH, PDCCH, etc. The data may be for the PDSCH, etc. The processor 320 may process (e.g., encode and symbol map) the data and control information to obtain data symbols and control symbols, respectively. The processor 320 may also generate reference symbols, e.g., for the PSS, SSS, and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120, the antennas 352a through 352r may receive the downlink signals from the base station 110 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120 to a data sink 360, and provide decoded control information to a controller/processor 380.

On the uplink, at the UE 120, a transmit processor 364 may receive and process data (e.g., for the PUSCH) from a data source 362 and control information (e.g., for the PUCCH) from the controller/processor 380. The processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the base station 110. At the base station 110, the uplink signals from the UE 120 may be received by the antennas 334, processed by the modulators 332, detected by a MIMO detector 336 if applicable, and further processed by a receive processor 338 to obtain decoded data and control information sent by the UE 120. The processor 338 may provide the decoded data to a data sink 339 and the decoded control information to the controller/processor 340.

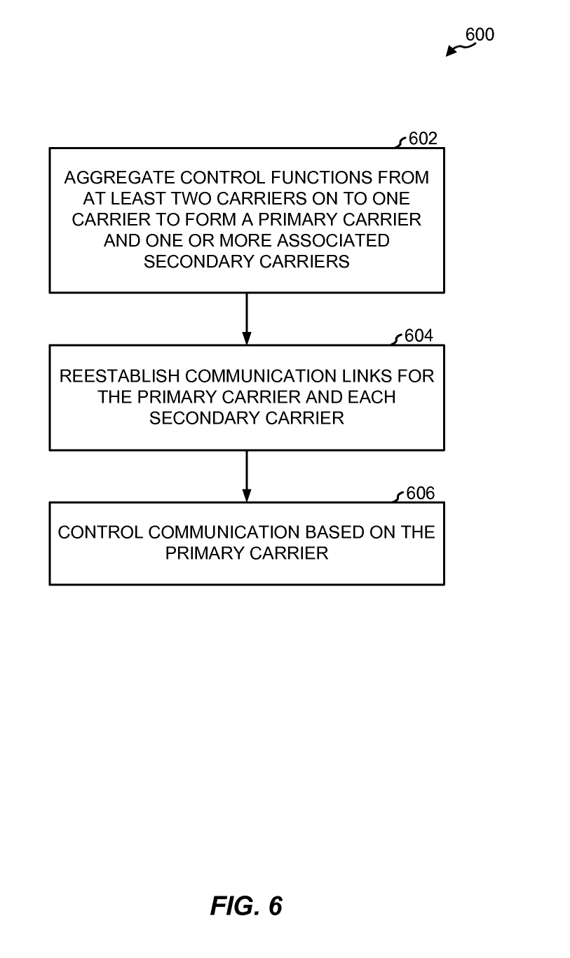

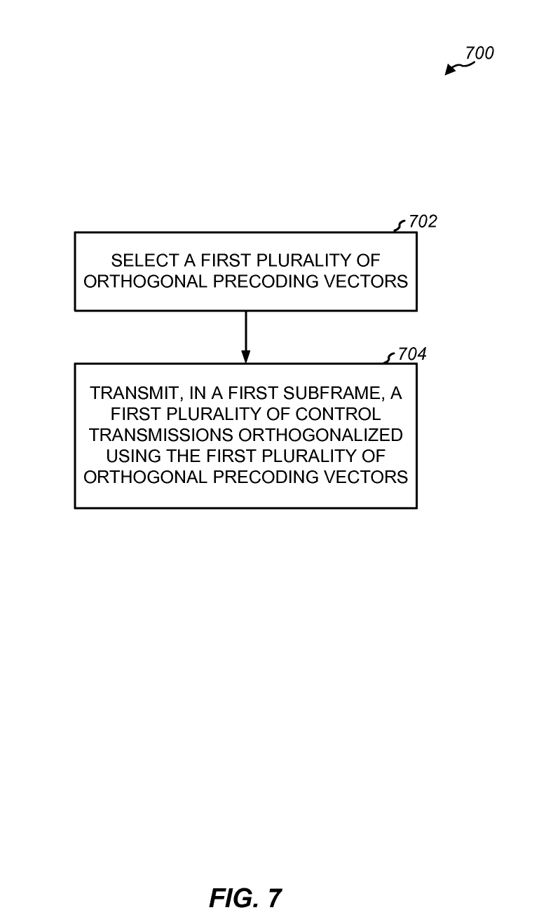

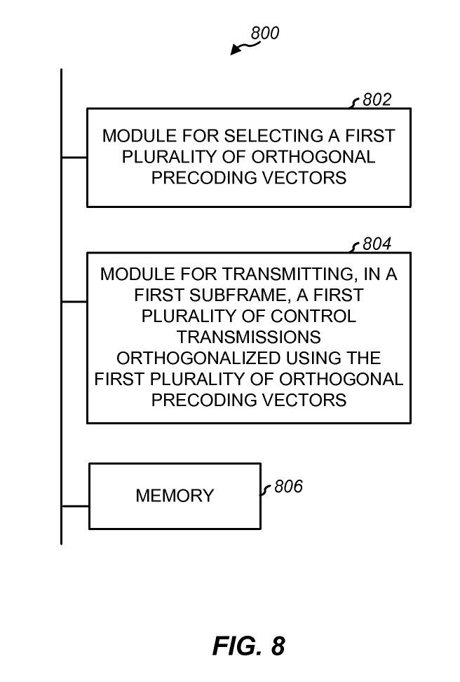

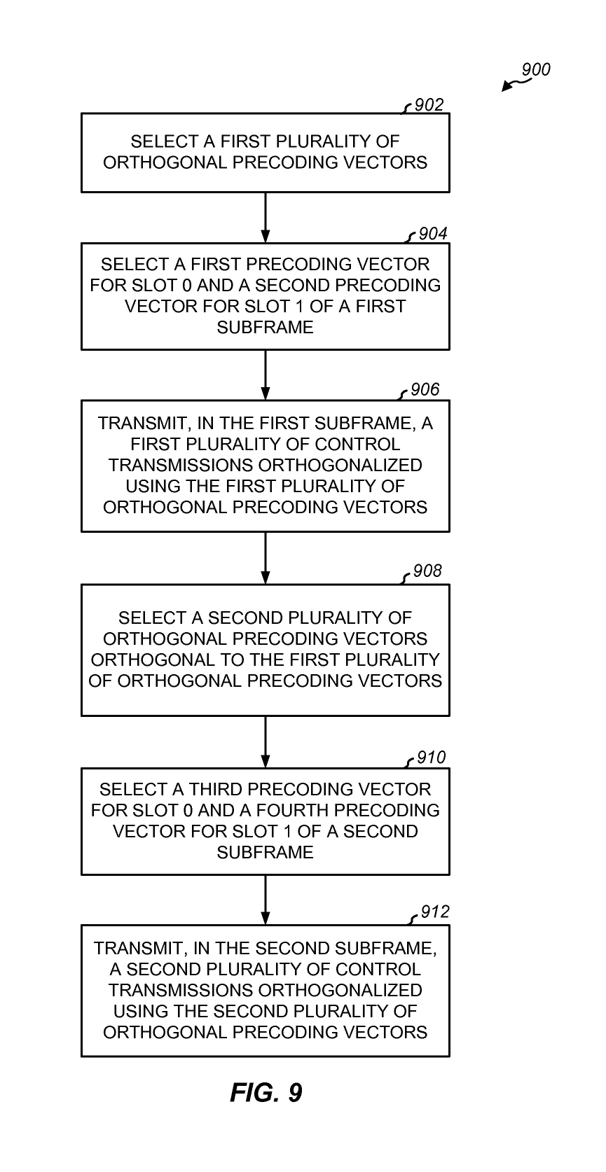

The controllers/processors 340 and 380 may direct the operation at the base station 110 and the UE 120, respectively. The processor 340 and/or other processors and modules at the base station 110 may perform or direct the execution of various processes for the techniques described herein. The processor 380 and/or other processors and modules at the UE 120 may also perform or direct the execution of the functional blocks illustrated in FIGS. 6 and 8, and/or other processes for the techniques described herein. In addition, for example, the processor 380 can comprise or at least be operatively coupled to modules illustrated in FIGS. 7 and 9 for performing aspects described herein. The memories 342 and 382 may store data and program codes for the base station 110 and the UE 120, respectively, which can include instructions for executing the methods in FIGS. 6 and 8, the modules in FIGS. 7 and 9, and/or the like. A scheduler 344 may schedule UEs for data transmission on the downlink and/or uplink.

### Carrier Aggregation

LTE-Advanced UEs can use spectrum in 20 Mhz bandwidths allocated in a carrier aggregation of up to a total of 100 Mhz (5 component carriers) used for transmission in each direction. Generally, less traffic is transmitted on the uplink than the downlink, so the uplink spectrum allocation may be smaller than the downlink allocation. For example, if 20 Mhz is assigned to the uplink, the downlink may be assigned 100 Mhz. These asymmetric FDD assignments can conserve spectrum and are a good fit for the typically asymmetric bandwidth utilization by broadband subscribers, though other assignments can be possible.

### Carrier Aggregation Types

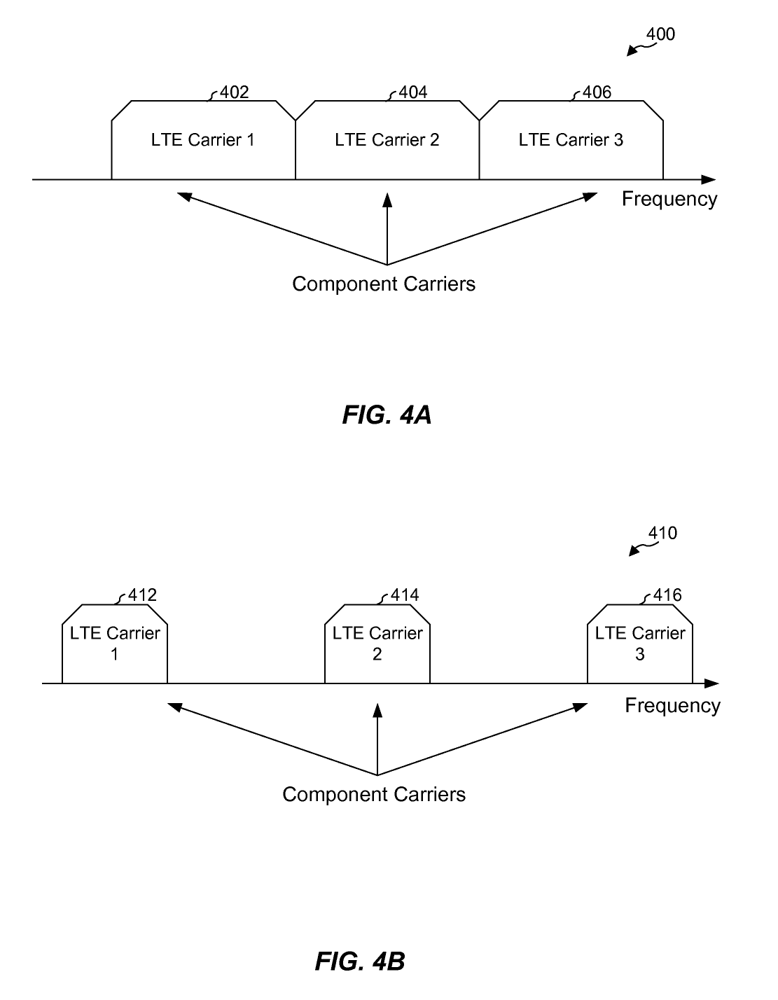

For the LTE-Advanced mobile systems, two types of carrier aggregation (CA) methods have been proposed, continuous CA and non-continuous CA, examples of which are illustrated in FIGS. 4A and 4B. Non-continuous CA occurs when multiple available component carriers 410 are separated along the frequency band (FIG. 4B). On the other hand, continuous CA occurs when multiple available component carriers 400 are adjacent to each other (FIG. 4A). As shown, for example, in continuous CA, carrier 1 402, carrier 2 404, and carrier 3 406 are adjacent in frequency. In non-continuous CA, carrier 1 412, carrier 2 414, and carrier 3 416 are not adjacent in frequency. Both non-continuous and continuous CA aggregate multiple LTE/component carriers to serve a single unit of LTE Advanced UE.

Multiple RF receiving units and multiple FFTs may be deployed with non-continuous CA in LTE-Advanced UE since the carriers are separated along the frequency band. Because non-continuous CA supports data transmissions over multiple separated carriers across a large frequency range, propagation path loss, Doppler shift and other radio channel characteristics may vary a lot at different frequency bands.

Thus, to support broadband data transmission under the non-continuous CA approach, methods may be used to adaptively adjust coding, modulation and transmission power for different component carriers. For example, in an LTE-Advanced system where the enhanced NodeB (eNB) has fixed transmitting power on each component carrier, the effective coverage or supportable modulation and coding of each component carrier may be different.

### Data Aggregation Schemes

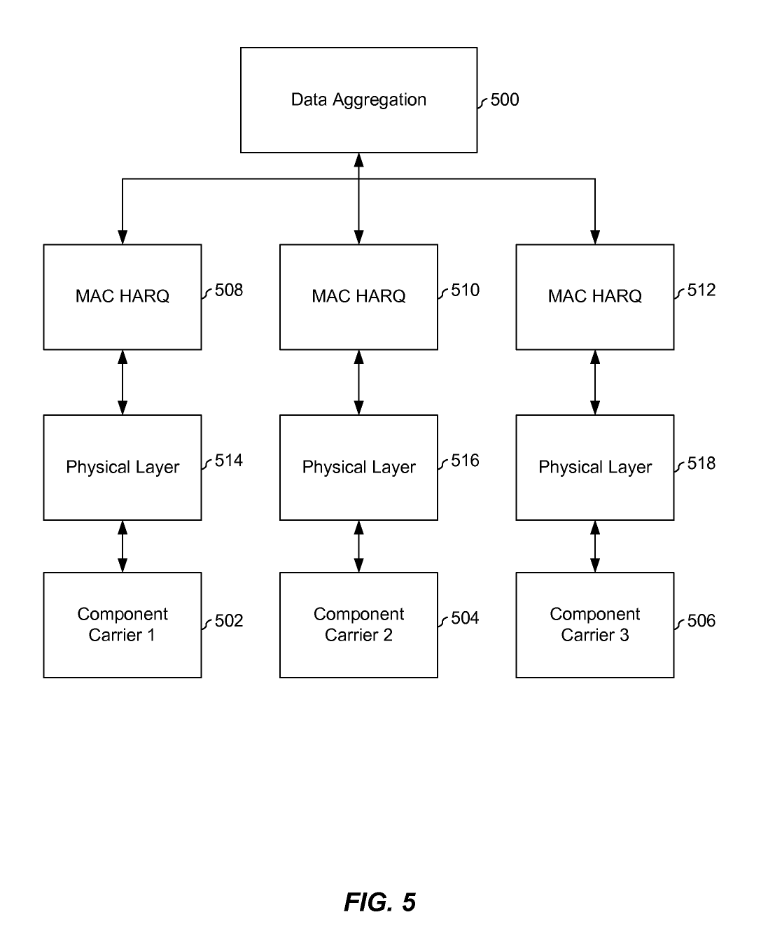

FIG. 5 illustrates performing data aggregation 500 to aggregate transmission blocks (TBs) from different component carriers 502, 504, and 506 at the medium access control (MAC) layer (FIG. 5) for an International Mobile Telecommunications (IMT)-Advanced or similar system. With MAC layer data aggregation, each component carrier has its own independent hybrid automatic repeat request (HARQ) entity 508, 510, and 512 in the MAC layer and its own transmission configuration parameters (e.g., transmitting power, modulation and coding schemes, and multiple antenna configuration) in the physical layer. Similarly, in the physical layer, one HARQ entity 514, 516, and 518 can be provided for each component carrier.

### Control Signaling

In general, there are three different approaches for deploying control channel signaling for multiple component carriers. The first involves a minor modification of the control structure in LTE systems where each component carrier is given its own coded control channel.

The second method involves jointly coding the control channels of different component carriers and deploying the control channels in a dedicated component carrier. The control information for the multiple component carriers can be integrated as the signaling content in this dedicated control channel. As a result, backward compatibility with the control channel structure in LTE systems is maintained, while signaling overhead in the CA is reduced.

Multiple control channels for different component carriers are jointly coded and then transmitted over the entire frequency band formed by a third CA method. This approach offers low signaling overhead and high decoding performance in control channels, at the expense of high power consumption at the UE side. However, this method is not compatible with LTE systems.

### Handover Control

It is preferable to support transmission continuity during the handover procedure across multiple cells when CA is used for IMT-Advanced UE. However, reserving sufficient system resources (e.g., component carriers with good transmission quality) for the incoming UE with specific CA configurations and quality of service (QoS) requirements may be challenging for the next eNB. The reason is that the channel conditions of two (or more) adjacent cells (eNBs) may be different for the specific UE. In one approach, the UE measures the performance of only one component carrier in each adjacent cell. This offers similar measurement delay, complexity, and energy consumption as that in LTE systems. An estimate of the performance of the other component carriers in the corresponding cell may be based on the measurement result of the one component carrier. Based on this estimate, the handover decision and transmission configuration may be determined.

FIG. 6 illustrates a methodology 600 for controlling radio links in a multiple carrier wireless communication system by grouping physical channels according to one example. As shown, the method includes, at block 602, aggregating control functions from at least two carriers onto one carrier to form a primary carrier and one or more associated secondary carriers. Next at block, 604, communication links are established for the primary carrier and each secondary carrier. Then, communication is controlled based on the primary carrier in block 606.

### Transmit Diversity in Multi-Carrier Configurations

Transmit diversity schemes can be defined for uplink control channel transmissions in a multi-antenna wireless communication system. Transmit diversity can be used, for example, to help overcome the effects of fading, outages, and circuit failures. Transmit diversity uses radio signals that originate from two or more sources which are independent and that have been modulated with identical or at least substantially similar information-bearing signals to communicate. Also, transmission characteristics of the radio signals may vary at a given period of time. Improvement for a received signal when using diversity transmission depends on the independence of the fading characteristics of the signal as well as circuit outages and failures, for example. In LTE, transmit diversity may be defined for one data stream for transmission over two and four transmit antennas configurations. The data stream may also be referred to as a codeword since one transport block cyclic redundancy check (CRC) is used for each data stream. One layer on LTE refers to one stream of data. The rank of the transmission is equal to the number of layers transmitted. The number of antenna ports can be greater than or equal to the number of layers, which can be greater than or equal to the number of codewords.

With codebook-based precoding, modulation symbols corresponding to transport blocks can be mapped to NL layers, where N is a number of transmit antennas, and L is a number of layers transmitted per transmit antenna. The layers can be mapped to the antenna ports. In addition, the antenna ports can correspond to physical and/or virtual antenna ports. In LTE, for example, there is a maximum of four antenna ports, and a maximum of four layers due to the fact that there is a maximum of four cell-specific reference signals in a cell and because codebook-based precoding relies on cell-specific reference signals for channel estimation.

In certain examples, such as the currently agreed upon version of Release 10 of LTE, abbreviated Rel-10, a physical uplink control channel (PUCCH) communication in format 1 may be transmitted using the one or more transmit diversity schemes. The PUCCH format 1 is a transmission channel format, which may carry information about scheduling requests where a UE, such as UE 120, or other remote terminal may request resources to transmit UL-shared channel (SCH). In some examples, space orthogonal resource transmit diversity (SORTD) may be used to improve transmit diversity. A SORTD method, for example, may be used to support the transmission of data (e.g., control data) from multiple transmit antennas. For the SORTD scheme, a different orthogonal resource may be assigned to each transmit antenna. Data may be sent from the multiple transmit antennas using multiple orthogonal resources. A UE 120 may process a first set of modulation symbols for transmission from the first transmit antenna using a first orthogonal resource. The UE 120 may process a second set of modulation symbols for transmission from the second transmit antenna using a second orthogonal resource. In these examples, the amount of orthogonal resources might be doubled. For four acknowledgement and/or negative acknowledgement (A/N) bits in HARQ or other retransmission scheme, eight orthogonal resources may be used for transmission. In one example, a modified SORTD scheme may be used by transmitting the same modulation symbols over two orthogonal resources.

In some other examples, a space code block coding (SCBC) scheme may be used for transmit diversity. In SCBC, multiple copies of a data stream across a number of antennas are transmitted. Reliability of the transferred data is improved by exploiting the various received versions of the data. Because of such factors such as scattering, reflection, refraction, etc., data received on some transmission paths may have an improved performance metric, such as signal to noise ratio (S/R), as compared to data received on other paths. By then combining the copies of the received signal, SCBC extracts more information than may be possible from just one of each received transmission path. Thus, there can be a higher chance of being able to use one or more of the received copies to correctly decode the received signal due to the redundancy. Such a design may keep the same amount of orthogonal resources (e.g., two) and transmit different modulation symbols over two orthogonal resources. For example, where symbol S is transmitted over one transmit (TX) antenna, applying SCBC to the symbol S can result in a conjugate of a complex-valued modulation of the signal, which can be either symbol +S* or −S*, transmitted over the other transmit antenna.

In another example, precoding vector switching (PVS) may be utilized to provide transmit diversity for signal transmissions. A UE, such as UE 120, 120 may use the PVS as follows, in one example. The UE 120 can select a first precoding vector (or matrix) for the first slot (e.g., slot 0 206 in FIG. 2) transmission in a subframe, while selecting a second precoding vector (or matrix), orthogonal to, or at least different from, the first precoding vector (or matrix), for the second slot (e.g., slot 1 208 in FIG. 2) transmission in the same subframe. The UE 120, for example, can change the orthogonal or different vector pair from one subframe to the next subframe. In addition, the orthogonal or different vector pairs selected between the one subframe and the next subframe need not be orthogonal to one another. The selection may be based on an operational criterion such as a measure of channel correlation (e.g., a channel correlation value). In another example, the precoding vectors may be pseudo-randomly switched when changing between subframes.

The orthogonality of the two precoding vectors, in this example, allows for transmit diversity. Specifically, the PVS, as described herein, can use open loop transmit diversity. With an open loop operation, the network does not select a precoder matrix based on feedback from the UE 120. Also, the receiving eNB 110 does not receive a report from the UE 120 about precoder configuration. That is, the two precoding vectors used by the UE 120 are transparent to the eNB 110 receiving the PUCCH. The precoding vectors need not be communicated to the eNB 110. Thus, the eNB 110 does not have to know the two precoding vectors to decode and demodulate the received PUCCH. Instead, the UE can select the precoder matrix in advance (e.g., according to a predefined or deterministic configuration).

As a non-limiting example, UE 120 can utilize the precoding vector [+1, +1] for precoding in slot 0 and the precoding vector [+1, −1] for precoding in slot 1 of the given subframe, or vice versa. In one aspect, from the perspective of the eNB 110, the transmission may be received as a single antenna transmission (e.g., due to orthogonalization resulting from the precoding vectors used in the two slots). That is, the eNB may decode the received signal as if it came from a single-input multiple-output (SIMO) user.

In some examples, the UE 120 may select the first and the second precoding vectors based on a channel correlation. For example, for correlated channels, the UE 120 may change the precoding vector pair used from one subframe to the next. In one aspect, as stated above, the selection of precoding vectors at a UE 120 may be transparent to a receiving eNB 110. That is, the eNB does not need to know what precoding vector was used to to correctly decode the received signal.

It is to be appreciated that the PVS scheme described above with respect to the transmission of PUCCH format 1 messages may align the transmit diversity scheme for the PUCCH format 1 message transmission to be similar to the transmit diversity schemes for other PUCCH formats. THE PUCCH may be transmitted on the primary component carrier. The PUCCH uses two slots of an uplink subframe. The PUCCH is allocated two resources located on the edges of the bandwidth allocated to a given carrier. Each resource consists of one resource block (e.g., 12 subcarriers) located within one of two slots of an uplink subframe. Information regarding scheduling requests from UEs can be carried by the PUCCH format 1. Scheduling requests can be used to request resources for uplink transmission. The PUCCH format 1 may also carry a HARQ acknowledgment.

In one aspect, the PVS scheme may result in antenna virtualization, effectively allowing UE 120 to transmit in a single antenna port mode over a plurality of physical antennas. In one aspect, the UE 120 may be able to use full power for the transmit diversity based transmission. In one aspect, due to mutual orthogonalization, antenna properties such as fading, antenna gain imbalance (AGI), etc. of one antenna may not impact the quality of transmission from the other antenna.

In some examples, UE 120 can use PVS over slots of a subframe for transmit diversity for substantially all PUCCH format 1 transmissions. For example, the various PUCCH format 1 messages carry different types of control information and use a different number of control bits per subframe. Specifically, the PUCCH format 1b with channel selection uses channel selection in addition to the two bits carried by quadrature phase-shift keying (QPSK) symbol per subframe to send HARQ A/N messages.

In conventional systems, such as the current version of Rel-10, PUCCH format 3 transmissions may be performed using SORTD, a frequency switched transmit diversity (FSTD) scheme, or a single-carrier space frequency block coding (SC-SFBC) scheme, as described below. For downlink carrier aggregation, multiple HARQ acknowledgment bits can be fed back on the uplink in the case of simultaneous transmission on multiple component carriers. PUCCH format 3 may be used for up to 20 bits of feedback relating to simultaneous transmission on multiple component carriers.

In SORTD, the same information may be transmitted over two orthogonal resources from two transmit antennas. In FSTD, first antenna may transmit over even tones (e.g., S0, 0, S1, 0, S2, 0, . . . ) and the second antenna may transmit over odd tones (e.g., 0, T0, 0, T1, 0, T2, . . . ). With space frequency block coding (SFBC), transmit diversity on two antenna ports is achieved by mapping two consecutive modulation symbols Sᵢ and Sᵢ₊₁ directly to frequency-adjacent resource elements on a first antenna port, where i represents the symbol number. On the second antenna port, the symbols are then frequency-swapped, and transformed −S*ᵢ₊₁ and S*ᵢ and then mapped to corresponding resource elements. In SC-SFBC, also called low-Cubic Metric SFBC, first antenna transmits the following symbols from tone 0 to tone 11 in one example: S0, S1, S2, S3, S4, S5, S6, S7, S8, S9, S10, S11. The second antenna in SC-SFBC transmits the following conjugates of complex-valued modulations symbols from tone 0 to tone 11 in this example: S5*, −S4*, S3*, −S2*, S1*, −S0*, S11*, −S10*, S9*, −S8*, S7*, −S6*.

In some examples, the above discussed PVS scheme may be applied to the transmission of PUCCH format 3 transmissions. For example, UE 120 can use a pair of orthogonal precoding vectors, the first one for slot 0 transmission in a subframe, and the second one for slot 1 transmission in the subframe. As previously noted, the PVS may be considered to be a particular realization of single antenna port mode (due to the orthogonalization).

In some examples, PVS may be utilized by the UE 120 for transmission of PUCCH format 3 messages when the UE 120 is not configured to transmit the PUCCH format 3 messages in another format (e.g., SORTD).

FIGS. 7 and 9 below illustrate example methodologies relating to transmitting data communications over slots of a subframe. While, for purposes of simplicity of explanation, the methodologies are shown and described as a series of acts, it is to be understood and appreciated that the methodologies are not limited by the order of acts, as some acts may, in accordance with one or more embodiments, occur concurrently with other acts and/or in different orders from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

FIG. 7 is a flowchart representation of a methodology 700 of wireless communication. At block 702, a first plurality of orthogonal precoding vectors is selected. The selection may be performed at a UE 120 based on a pre-stored, hardcoded, or otherwise configured set of orthogonal precoding vectors. In some examples, the selection may be performed based on an operational parameter such as an antenna configuration, a channel correlation value, and so on. At block 704, a first plurality of control transmissions may be transmitted in a first subframe. The control transmission may be orthogonalized within multiple slots of a subframe using the first plurality of orthogonal precoding vectors, as described above.

FIG. 8 is a block diagram representation of a portion of a wireless communication apparatus 800 comprising module 802 for selecting a first plurality of orthogonal precoding vectors and module 804 for transmitting, in a first subframe, a first plurality of control transmissions orthogonalized using the first plurality of orthogonal precoding vectors. The apparatus 800 also includes memory 806 within which the modules 802 and 804 can be implemented. Additionally or alternatively, memory 806 can include instructions for executing modules 802 and 804, parameters related to modules 802 and 804, and/or the like. The apparatus 800 may further implement various techniques described herein. In one example, the apparatus 800 can include a UE 120 with additional components to perform the techniques described herein (e.g., a processor 380 to execute associated instructions, and/or the like).

FIG. 9 is a flowchart representation of a methodology 900 of wireless communication. At block 902, a first plurality of orthogonal precoding vectors is selected. For example, this can include a UE 120 selecting the set of available precoding vectors according to a predefined or otherwise configured selection, a predefined or configured pattern, a random pattern, a pseudo-random pattern (e.g., based on device identifier or other parameters), and/or the like. At block 904, a first precoding vector may be selected for the first slot (slot 0) transmission in a first subframe and a second precoding vector, orthogonal to the first precoding vector, may be selected for the second slot (slot 1) in the first subframe. The selection may be performed at a UE 120 based on a pre-stored set of orthogonal precoding vectors and/or one or more selection patterns, as described with respect to the set of available precoding vectors. Thus, in some examples, the selection may be performed based on an operational parameter such as antenna configuration, a channel correlation value, and so on. At block 906, a first plurality of control transmissions may be transmitted in the first subframe. The control transmission may be orthogonalized using the first plurality of orthogonal precoding vectors, as described above.

At block 908, a second plurality of orthogonal precoding vectors is selected, wherein the precoding vectors in the second plurality of orthogonal vectors are different from the precoding vectors in the first plurality of orthogonal precoding vectors. The second plurality of orthogonal vectors can similarly be selected by UE 120 based on one or more configurations and/or patterns, and can be different from the first plurality of orthogonal vectors. At block 910, a third precoding vector may be selected for the first slot (slot 0) transmission in a second subframe and a fourth precoding vector, orthogonal to the third precoding vector, may be selected for the second slot (slot 1) in the second subframe. In one specific example, the third precoding vector can be the same as the second precoding vector, and the fourth precoding vector can be the same as the first precoding vector. At block 912, a second plurality of control transmissions may be transmitted in the second subframe using the second plurality of orthogonal precoding vectors. Thus, transmissions are orthogonal across slots and can also be orthogonal across adjacent subframes to provide transmit diversity.

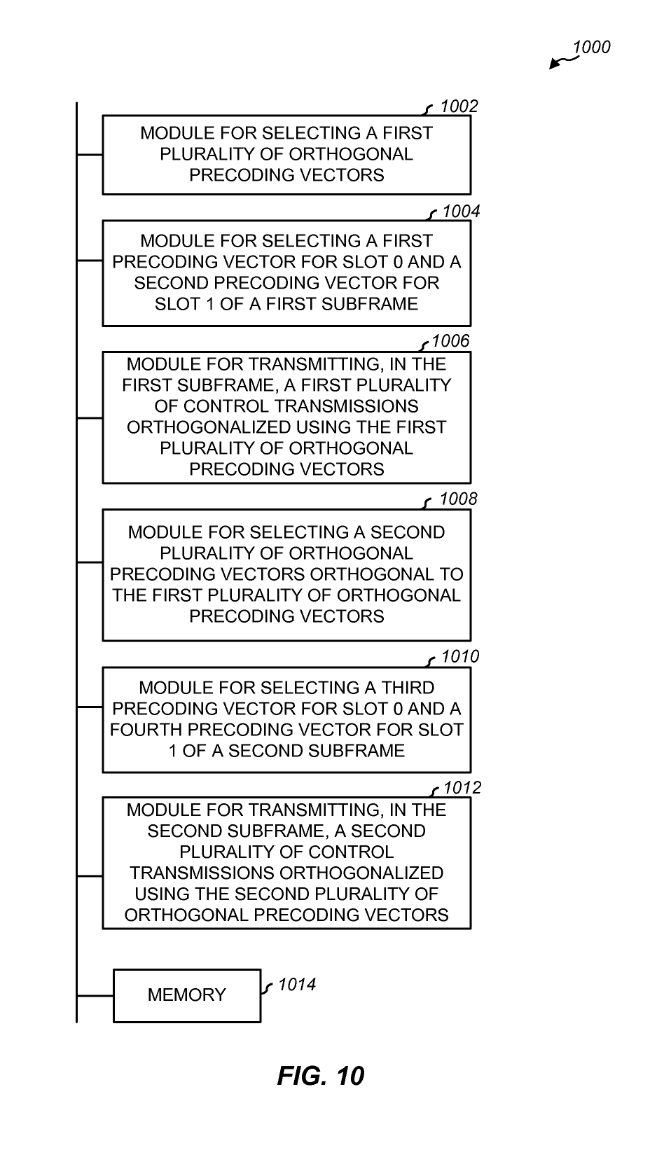

FIG. 10 is a block diagram representation of a portion of a wireless communication apparatus 1000 comprising module 1002 for selecting a first plurality of orthogonal precoding vectors. Apparatus 1000 also comprises a module 1004 for selecting a first precoding vector for the first slot (slot 0) transmission in a first subframe and selecting a second precoding vector, orthogonal to the first precoding vector, for the second slot (slot 1) in the first subframe. Apparatus 1000 also comprises a module 1006 for transmitting, in the first subframe, a first plurality of control transmissions orthogonalized using the first plurality of orthogonal precoding vectors. Apparatus 1000 also comprises a module 1008 for selecting a second plurality of orthogonal precoding vectors, wherein the precoding vectors in the second plurality of orthogonal vectors are orthogonal to precoding vectors in the first plurality of orthogonal precoding vectors. Apparatus 1000 also comprises a module 1010 for selecting a third precoding vector for the first slot (slot 0) transmission in a second subframe and selecting a fourth precoding vector, orthogonal to the third precoding vector for the second slot (slot 1) in the second subframe. Apparatus 1000 also comprises a module 1012 for transmitting a second plurality of control transmissions in the second subframe. The apparatus 1000 also includes memory 1014 within which the modules 1002, 1004, 1006, 1008, 1010, and 1012 can be implemented. Additionally or alternatively, memory 1014 can include instructions for executing modules 1002, 1004, 1006, 1008, 1010, and 1012, parameters related to modules 1002, 1004, 1006, 1008, 1010, and 1012, and/or the like. The apparatus 1000 may further implement various techniques described herein. In one example, the apparatus 1000 can include a UE 120 with additional components to perform the techniques described herein (e.g., a processor 380 to execute associated instructions, and/or the like).

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A method for transmitting wirelessly using transmit diversity, said method comprising:
selecting a first plurality of orthogonal precoding vectors; and
transmitting, in a first subframe, a first plurality of control transmissions orthogonalized using the first plurality of orthogonal precoding vectors.

2. The method of claim 1, wherein the first plurality of control transmissions comprise a physical uplink control channel (PUCCH) format.

3. The method of claim 2, wherein the PUCCH format is one of a format 1b with channel selection or a format 3 PUCCH message.

4. The method of claim 1, wherein the first plurality of control transmissions comprises a slot 0 transmission and a slot 1 transmission.

5. The method of claim 4, wherein the transmitting comprises transmitting one of the first plurality of control transmissions in a first slot of the first subframe as the slot 0 transmission according to a first one of the first plurality of precoding vectors, and transmitting one of the first plurality of control transmissions in a second slot of the first subframe as the slot 1 transmission according to a second one of the first plurality of precoding vectors.

6. The method of claim 5, further comprising selecting the first one of the first plurality of precoding vectors and the second one of the first plurality of precoding vectors using precoding vector switching.

7. The method of claim 6, wherein the selecting the first one of the first plurality of precoding vectors and the second one of the first plurality of precoding vectors comprises using open loop transmit diversity.

8. The method of claim 1, further comprising transmitting, in a second subframe, a second plurality of control transmissions orthogonolized using a second plurality of orthogonal precoding vectors.

9. The method of claim 8, wherein a second set of precoding vectors in the second plurality of orthogonal precoding vectors are not orthogonal to at least a first set of precoding vectors in the first plurality of orthogonal precoding vectors.

10. The method of claim 8, further comprising pseudo-randomly switching among the first plurality of orthogonal precoding vectors and the second plurality of orthogonal precoding vectors when changing from the first subframe to the second subframe.

11. The method of claim 1, wherein the selecting comprises selecting, based on an operational parameter, the first plurality of orthogonal precoding vectors.

12. The method of claim 11, wherein the operational parameter comprises a channel correlation value.

13. An apparatus for transmitting wirelessly using transmit diversity, said apparatus comprising:
means for selecting a first plurality of orthogonal precoding vectors; and
means for transmitting, in a first subframe, a first plurality of control transmissions orthogonalized using the first plurality of orthogonal precoding vectors.

14. The apparatus of claim 13, wherein the first plurality of control transmissions comprise a physical uplink control channel (PUCCH) format.

15. The apparatus of claim 14, wherein the PUCCH format is one of a format 1b with channel selection or a format 3 PUCCH message.

16. The apparatus of claim 13, wherein the first plurality of control transmissions comprises a slot 0 transmission and a slot 1 transmission.

17. The apparatus of claim 16, wherein the means for transmitting transmits one of the first plurality of control transmissions in a first slot of the first subframe as the slot 0 transmission according to a first one of the first plurality of precoding vectors, and transmits one of the first plurality of control transmissions in a second slot of the first subframe as the slot 1 transmission according to a second one of the first plurality of precoding vectors.

18. The apparatus of claim 17, further comprising means for selecting the first one of the first plurality of precoding vectors and the second one of the first plurality of precoding vectors using precoding vector switching.

19. The apparatus of claim 18, wherein the means for selecting selects the first one of the first plurality of precoding vectors and the second one of the first plurality of precoding vectors using an open loop transmit diversity.

20. The apparatus of claim 13, further comprising means for transmitting, in a second subframe, a second plurality of control transmissions orthogonolized using a second plurality of orthogonal precoding vectors.

21. The apparatus of claim 20, wherein a second set of precoding vectors in the second plurality of orthogonal precoding vectors are not orthogonal to a first set of precoding vectors in the first plurality of orthogonal precoding vectors

22. The apparatus of claim 20, wherein the means for transmitting pseudo-randomly switches among the first plurality of orthogonal precoding vectors and the second plurality of orthogonal precoding vectors when changing from the first subframe to the second subframe.

23. The apparatus of claim 13, wherein the means for selecting selects the first plurality of orthogonal precoding vectors based on an operational parameter.

24. The apparatus of claim 23, wherein the operational parameter comprises a channel correlation value.

25. A computer program product for transmitting wirelessly using transmit diversity comprising:
a non-transitory computer-readable medium comprising:
code for causing at least one computer to select a first plurality of orthogonal precoding vectors; and
code for causing the at least one computer to transmit, in a first subframe, a first plurality of control transmissions orthogonalized using the first plurality of orthogonal precoding vectors.

26. The computer program product of claim 25, wherein the first plurality of control transmissions comprise a physical uplink control channel (PUCCH) format.

27. The computer program product of claim 26, wherein the PUCCH format comprises one of a format 1b with channel selection or a format 3 PUCCH message.

28. The computer program product of claim 25, wherein the first plurality of control transmissions comprises a slot 0 transmission and a slot 1 transmission.

29. The computer program product of claim 28, wherein the code for causing the at least one computer to transmit transmits one of the first plurality of control transmissions in a first slot of the first subframe as the slot 0 transmission according to a first one of the first plurality of precoding vectors, and transmits one of the first plurality of control transmissions in a second slot of the first subframe as the slot 1 transmission according to a second one of the first plurality of precoding vectors.

30. The computer program product of claim 29, wherein the computer-readable medium further comprises code for causing the at least one computer to select the first one of the first plurality of precoding vectors and the second one of the first plurality of precoding vectors using precoding vector switching.

31. The computer program product of claim 30, wherein the code for causing the at least one computer to select selects the first one of the first plurality of precoding vectors and the second one of the first plurality of precoding vectors using an open loop transmit diversity.

32. The computer program product of claim 25, wherein the computer-readable medium further comprises code for causing the at least one computer to transmit, in a second subframe, a second plurality of control transmissions orthogonolized using a second plurality of orthogonal precoding vectors.

33. The computer program product of claim 32, wherein a second set of precoding vectors in the second plurality of orthogonal precoding vectors are not orthogonal to a first set of precoding vectors in the first plurality of orthogonal precoding vectors.

34. The computer program product of claim 32, wherein the code for causing the at least one computer to transmit pseudo-randomly switches among the first plurality of orthogonal precoding vectors and the second plurality of orthogonal precoding vectors when changing from the first subframe to the second subframe.

35. The computer program product of claim 25, wherein the code for causing the at least one computer to select selects the first plurality of orthogonal precoding vectors based on an operational parameter.

36. The computer program product of claim 35, wherein the operational parameter comprises a channel correlation value.

37. A user equipment (UE) supporting uplink transmit diversity, said UE comprising:
at least one processor; and
a memory coupled to said at least one processor, wherein said at least one processor is configured to:
select a first plurality of orthogonal precoding vectors; and
transmit, in a first subframe, a first plurality of control transmissions orthogonalized using the first plurality of orthogonal precoding vectors.

38. The UE of claim 37, wherein the first plurality of control transmissions comprise a physical uplink control channel (PUCCH) format.

39. The UE of claim 38, wherein the PUCCH format comprises one of a format 1b with channel selection or a format 3 PUCCH message.

40. The UE of claim 37, wherein the first plurality of control transmissions comprises a slot 0 transmission and a slot 1 transmission.

41. The UE of claim 40, wherein the at least one processor transmits one of the first plurality of control transmissions in a first slot of the first subframe as the slot 0 transmission according to a first one of the first plurality of precoding vectors, and transmits one of the first plurality of control transmissions in a second slot of the first subframe as the slot 1 transmission according to a second one of the first plurality of precoding vectors.

42. The UE of claim 41, wherein the at least one processor is further configured to select the first one of the first plurality of precoding vectors and the second one of the first plurality of precoding vectors using precoding vector switching.

43. The UE of claim 42, wherein the at least one processor selects the first one of the first plurality of precoding vectors and the second one of the first plurality of precoding vectors using open loop transmit diversity.

44. The UE of claim 37, wherein the at least one processor is further configured to transmit, in a second subframe, a second plurality of control transmissions orthogonolized using a second plurality of orthogonal precoding vectors.

45. The UE of claim 44, wherein a second set of precoding vectors in the second plurality of orthogonal precoding vectors are not orthogonal to a first set of precoding vectors in the first plurality of orthogonal precoding vectors.

46. The UE of claim 44, wherein the at least one processor is further configured to pseudo-randomly switch among the first plurality of orthogonal precoding vectors and the second plurality of orthogonal precoding vectors when changing from the first subframe to the second subframe.

47. The UE of claim 37, wherein the at least one processor selects the first plurality of orthogonal precoding vectors based on an operational parameter.

48. The UE of claim 47, wherein the operational parameter comprises a channel correlation value.
